(19) United States
(12) Patent Application Publication
(10) Pub. No.: US 2008/0133543 A1
(43) Pub. Date: Jun. 5, 2008

(54) System and Method for Dynamic and On-Demand Data Transfer and Synchronization Between Isolated Networks

(75) Inventors: Xiaozhou Fu, San Diego, CA (US); Zaw Naing L. Oo, San Diego, CA (US); Xin Qiu, San Diego, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/947,902

(22) Filed: Nov. 30, 2007

Related U.S. Application Data
(60) Provisional application No. 60/868,213, filed on Dec. 1, 2006.

(51) Int. Cl. G06F 17/30

(52) U.S. Cl. 707/10; 707/E17.001

(57) ABSTRACT

A system, method and computer-readable medium of instructions for performing dynamic and on-demand data transfer between databases (116, 124) in public and secure networks (102, 104), and synchronization of those databases (116, 124), in a public key infrastructure (PKI) environment. The system, method and computer-readable medium of instructions operate to identify at least one record of information in the database (116) of the public network (102) to be updated in the database (124) of the private network (104), enter update information in at least one data transfer table (400, 600/602) based on the at least one record of information, and use the at least one data transfer table (400, 600/602) to update at least one record in the database (124) of the private network (104) in accordance with the update information without overwriting other information in the database (124).

This application claims benefit from U.S. Provisional Application No. 60/868,213, filed on Dec. 1, 2006, the entire content being incorporated herein by reference.

### FIELD OF THE INVENTION

The present invention relates generally to data transfer between databases in public and isolated networks. More particularly, the present invention relates to a system and method for performing dynamic and on-demand data transfer between databases in public and isolated networks, and synchronization of those databases, in a public key infrastructure (PKI) environment.

### BACKGROUND

It is common for a PKI network to be arranged as two isolated networks for security reasons. In such an arrangement, one network can be connected to the public network, such as the Internet, while the other network is a “locked-down” network having no outside connection. This locked-down network can be used for generating a PKI key/certificate/digital ID based on a received request. Typically, the secure devices and application used for generating the PKI private key, certificate and digital ID, for example, are placed and operated in off-line machines that are physically secure from external intrusion. The PKI request data can be manually loaded into the locked down network in order to perform the key/certificate/digital ID generating operations.

In this type of PKI network, there can be two database instances present, namely, an Online Request Database and an Offline PKI Generation Database. The Online Request Database is used by the front end server of the network that receives the PKI request, and can be placed behind the network firewall for security reasons. The Offline PKI Generation Database is located in the locked-down network and is used for PKI key/certificate/digital ID generation as discussed above.

As can be appreciated by one skilled in the art, some of the tables and data content stored in the two databases need to be mirrored to remain identical. To ensure consistency of data content and data history, the databases would need to be synchronized continuously. However, it can be difficult to synchronize the two databases using know data synchronization methods that can be built into the database packages. For example, Structured Query Language (SQL) Data Transformation Services is an SQL utility that could be used for transferring data. However, this type of utility does not support binary data format, and in both databases instances, the X.509 certificates, keys and PKI generation workflow components, for example, are typically stored in binary format.

In addition, the backup and restore features built into the SQL utility will overwrite the entire database and thus erase every record in all of the tables. The SQL utility does not have the ability to select tables and rows to have “write protection” capability. Thus, when both databases have undergone changes and/or additions, the backup and restore method would only copy the changes from the source tables to the target tables and thus overwrite any changes that had occurred in the target tables since the last synchronization. Accordingly, the SQL utility would not enable the databases to maintain a history of the PKI requests and generation information in the tables. Furthermore, to download each PKI request, the “backup-restore” command would need to be executed on the database server directly using the SQL management tool, and could not be carried our remotely, therefore requiring physical access to the secure facilities that houses the servers. Also, if the backup-restore function is not performed properly, data can inadvertently be deleted, modified or corrupted.

On the other hand, Data File Transferring (DFT) can be viewed as the most common data transfer method used by commercial applications. However, it is difficult to use this method to handle variable-length data fields and binary data fields, and if the database schema changes, the application needs to be changed and retested. In addition, although known database replication techniques can be used to replicate entire tables and selected columns in tables, they cannot replicate data on a row by row basis.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a conceptual diagram illustrating an example of a PKI network employing an embodiment of the present invention;

FIG. 2 is a flow diagram illustrating an example of operations that are performed by the network shown in FIG. 1 in accordance with a trigger based mechanism for data transfer in an embodiment of the present invention;

FIG. 3 is a flow diagram illustrating an example of operations that are performed by the network shown in FIG. 1 in accordance with a request based mechanism for data transfer in an embodiment of the present invention;

FIG. 4 is a diagram illustrating an example of the use of a transfer table to transfer information between databases in the network show in FIG. 1 according to an embodiment of the present invention;

FIGS. 5 and 6 present a diagram illustrating an example of the manner in which a transfer table as shown in FIG. 4 is constructed according to an embodiment of the present invention;

FIG. 7 is a diagram illustrating an example of the use of a transfer table and transfer detail table to transfer information between databases in the network show in FIG. 1 according to an embodiment of the present invention; and

FIGS. 8 and 9 present a diagram illustrating an example of the manner in which a transfer table and transfer detail table as shown in FIG. 6 are constructed according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to data transfer between databases in public and isolated networks. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a system for transferring data between databases in public and isolated networks described herein. The non-processor circuits may include, but are not limited to, a radio receiver, a radio transmitter, signal drivers, clock circuits, power source circuits, and user input devices. As such, these functions may be interpreted as steps of a method to perform operations for transferring data between databases in public and isolated networks as described herein.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

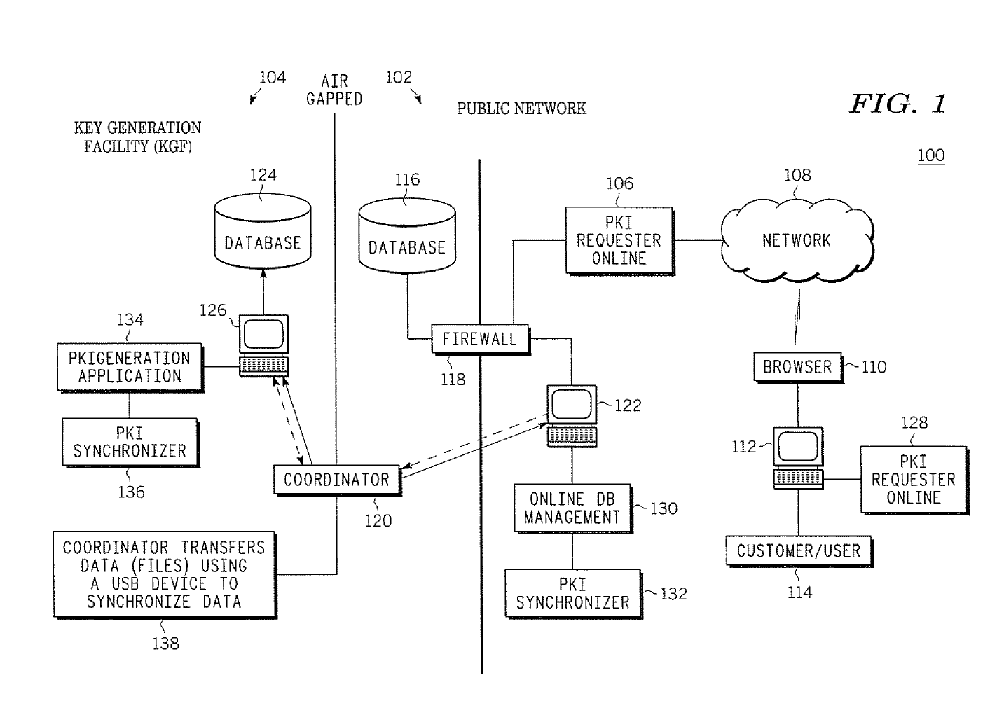

FIG. 1 illustrates an example of a PKI network 100 employing embodiments of the present invention described herein. As shown, the PKI network includes a public network 102 and a key generation facility 104. The public network 102 includes a server 106 that is accessible via another network 108, such as the Internet, through the use of a browser 110 running on a workstation 112 of a user 1 14. As discussed in the Background section above, the public network 102 includes Online Request Database instances (database 116) that is used by the server 106 of the public network 102 that receives a PKI request from, for example, the user 114. The database 116 can be placed behind the network firewall 118 for security reasons, and is accessible by, for example, a coordinator 120 via a workstation 122. The workstation 122 can run or perform tasks associated with an online database manager 130, as well as a PKI synchronizer application 132 that can be integrated with the online database manager, as discussed in more detail below.

As further shown in FIG. 1, the key generation facility 104 is “air-gapped” isolated from the public network 102 and thus, as would be understood by one skilled in the art, is a “locked-down” network having no outside connection and can thus be completely physically, electrically and electromagnetically isolated from the public network 102. This locked-down key generation facility 104 can be used for generating a PKI key/certificate/digital ID based on a received request that is handled by the coordinator 120. That is, the PKI request data can be manually loaded into the locked-down key generation facility 104 by the coordinator 120 so that the key generation facility 104 can perform the key/certificate/digital ID generating operations.

As discussed in more detail below, the key generation facility 104 includes Offline PKI Generation Database instances (database 124) that is located in the locked-down network and is accessible by the coordinator 120 via, for example, a workstation 126 in order to generate a PKI key/certificate/digital ID. That is, as shown in FIG. 1, the coordinator 120 can use a universal serial bus (USB) device, or any other suitable device, to transfer information such as data, files and the like, between workstations 122 and 126, and thus between the public network 102 and key generation facility 104. The workstation 126 can run or perform tasks associated with a PKI generation application 134, as well as a PKI synchronizer that can be integrated with the PKI generation application 136, as discussed in more detail below.

As will now be described, the embodiments of the present invention provide a system and method which dynamically generates a file or files that can be transferred manually, for example, by the coordinator 120, between the database 116 and the database 124 whenever a PKI request is generated or received from, for example, a user 114. The embodiments of the present invention support different data types of variable length, and are capable of matching different database schemas dynamically without requiring code changes.

To achieve this, the embodiments of the present invention can convert the database tables into one or two generic “data transferring” tables which are not dependant on the definition of the original or source tables. Since the schema of database tables could be dynamically parsed at the time when an application is run, a pre-defined schema is not necessary. Hence, any database schema change in the future would not require any code change. Also, the embodiments can operate in networks using different databases such as MS SQL and Oracle.

Once the data records, files and so on have been move to data the transferring table or tables from the original tables, the PKI synchronizer application running in the public network 104 as discussed above with regard to FIG. 1 operates as a data transfer agent to download records to a file, such as a Microsoft Access file. The Microsoft Access file can then be moved manually to the target tables in the isolated key generation facility 104 under the control of the coordinator 120 through the use of, for example, a USB device or other suitable device. The PKI synchronizer application running at the isolated key generation facility 104 as discussed above with regard to FIG. 1 will operate as the data transfer agent to upload the file to the transfer table or tables. All of the records then will have been moved to the target tables.

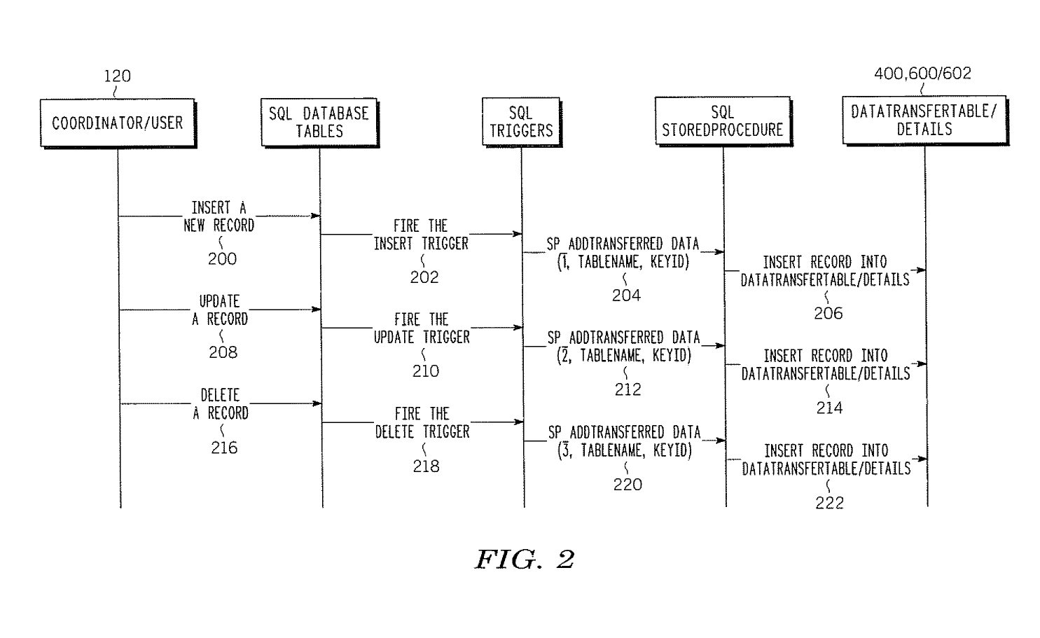

FIG. 2 is a flow diagram illustrating an example of operations performed when using a database trigger mechanism to insert a new record into a database, in particular, the database 124, to update a record in the database, or to delete a record from the database. As indicated, a database trigger can be created as, for example, part of the PKI Synchronizer running at the public network 102, to generate procedural code that is automatically executed in response to certain events, such as “insert,” “update” and “delete” for every record (e.g. every row) of a particular table in the database 124.

As shown in the example of FIG. 2, when the coordinator 120 wishes to insert a new record into database 124, the coordinator 120 can enter the insert request via the workstation 122 in operation 200. The database trigger will fire the insert trigger in operation 202. In response, the insert trigger will create a record including the information to be inserted, as shown in operation 204. In operation 206, the insert trigger will then place the record in a data transfer table or tables which are discussed in more detail below.

Similarly, as further shown in the example of FIG. 2, when the coordinator 120 wishes to update a record in database 124, the coordinator 120 can enter the update request via the workstation 122 in operation 208. The database trigger will the fire the update trigger in operation 210. In response, the update trigger will create a record including the information to be updated, as shown in operation 212. In operation 214, the update trigger will then place the record in a data transfer table or tables which are discussed in more detail below.

Likewise, when the coordinator 120 wishes to delete a record in database 124, the coordinator 120 can enter the delete request via the workstation 122 in operation 216. The database trigger will the fire the delete trigger in operation 218. In response, the delete trigger will create a record including the information to be deleted, as shown in operation 220. In operation 222, the delete trigger will then place the record in a data transfer table 400 or tables 600/602 which are discussed in more detail below.

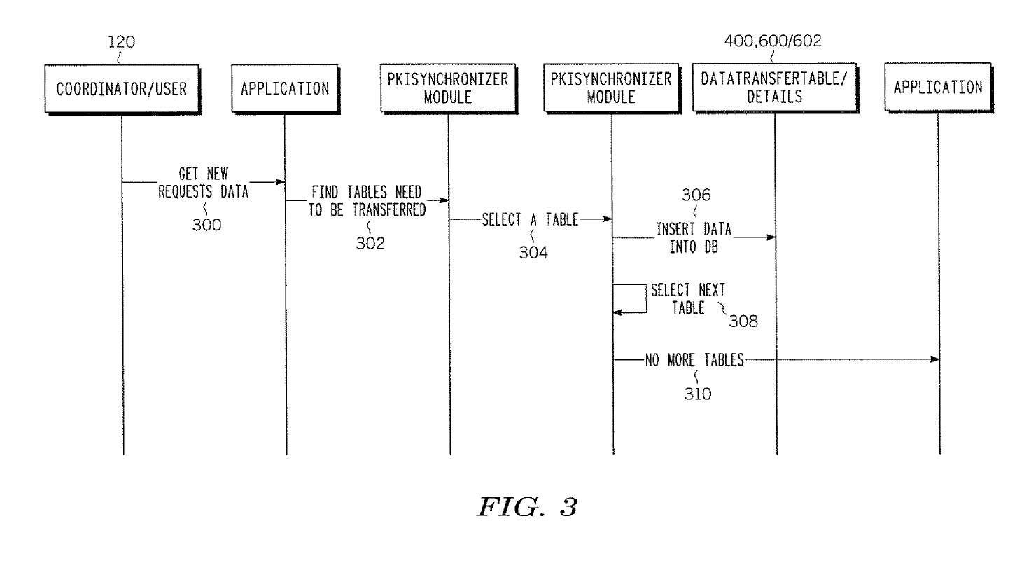

FIG. 3 is a flow diagram illustrating an example of operations performed when using a request based mechanism to transfer data into a database, in particular, the database 124. In using this technique, the coordinator 120 can select all of the requests since the last time that a data transfer has taken place. Also, the coordinator 120 can select a specific PKI request which corresponds to multiple records in several tables.

As shown in FIG. 3, when the coordinator 120 selects the request data using, for example, the workstation 122 in operation 300, the PKI synchronizer application changes the status of the request from “pending” to “in-process.” In operation 302, the PKI synchronizer application finds the tables in the database 116 that need to be transferred to the database 124. PKI synchronizer application then selects a table in operation 304, and in operation 306 inserts data into a data transfer table 400 or tables 600/602 which are discussed in more detail below. The PKI synchronizer application then performs operation 308 to select another table, and repeats operation 306 as shown until it is determined in operation 310 that no more tables to be transferred remain. In operation 310, the data transfer table or tables are then saved to a device, such as a USB device as discussed above, that the coordinator 120 can use to load the information in data transfer table 400 or tables 600/602 into the database 124.

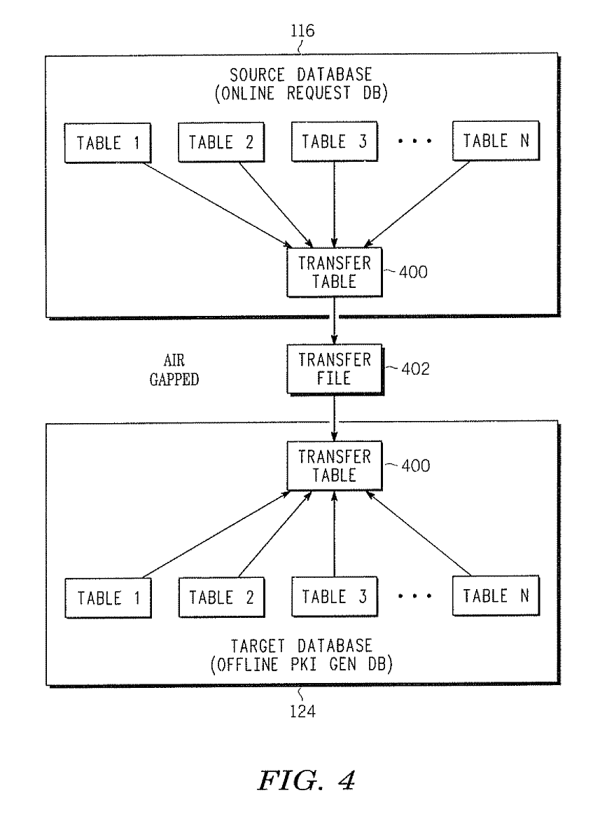

Examples of transfer tables mentioned above will now be discussed with regard to FIGS. 4-7.

FIG. 4 illustrates an example of the manner in which a single generic transfer table 400 can be used to transfer information from Tables 1 through n in a source database, such as database 116, to Tables 1 through n in a target database, such as database 124, according to an embodiment of the present invention. As can be appreciated by one skilled in the art, certain SQL system calls can be made by the PKI Synchronizer application, for example, when the coordinator 120 wishes to transfer, update or delete data using the database trigger mechanism or request based mechanism as discussed above with regard to FIGS. 2 and 3. The SQL system calls can retrieve information such as table name, number of columns in a table, column type, column name, column size and so on, from the Tables 1 through n of the database 116. This retrieved information is then used to dynamically build scripts to gather data from all of the Tables 1 through n of the database 116 and place the gathered data in the transfer table 400. Once the transfer table 400 has been built, the table 400 is converted to a transfer file. The coordinator 120 can then load the file onto a device 402, such as a USB device as discussed above, to transfer the information in the transfer table 400 to the Tables 1 through n of the database 124 in the manner discussed above (e.g., using the workstation 126).

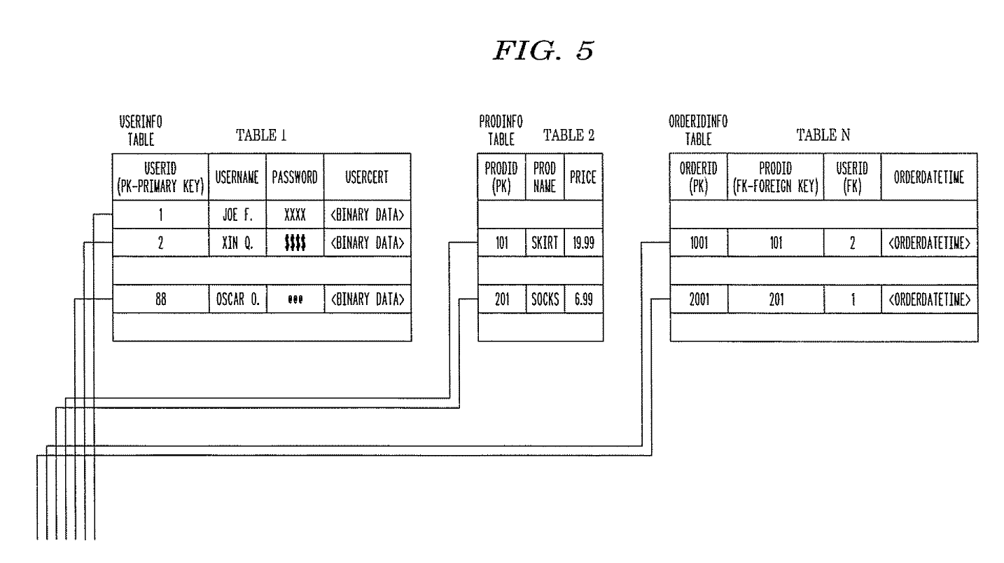

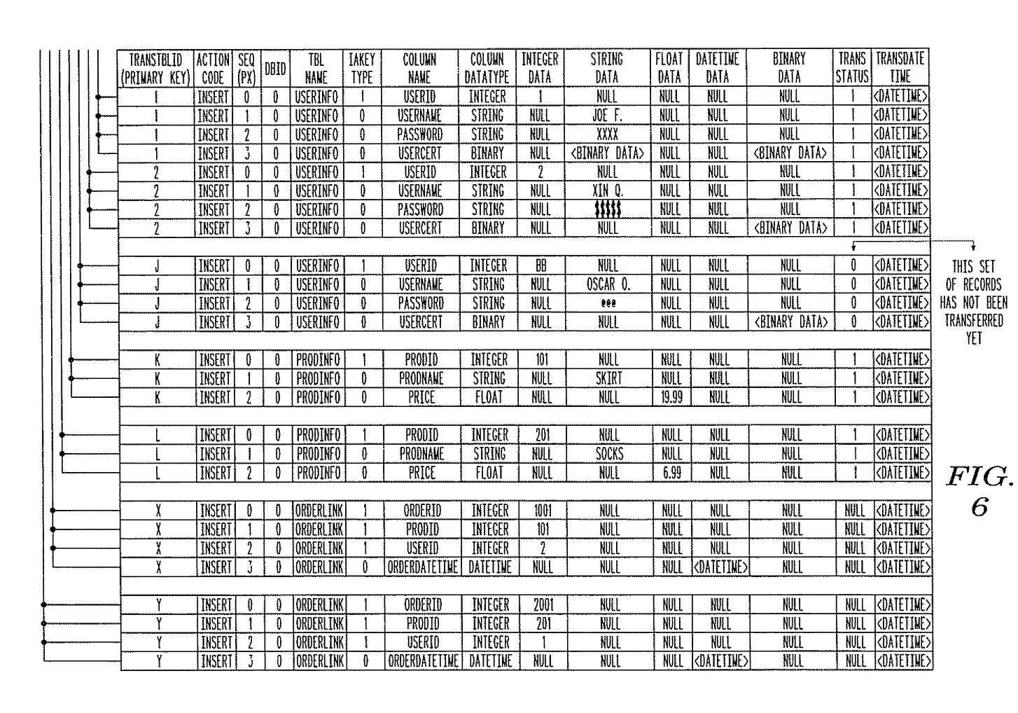

As shown in FIGS. 5 and 6, according to an embodiment of the present invention, the single generic transfer table 400 can be used to hold the information that needs to be transferred from the source tables to the target tables or, in other words, from the database 116 to the database 124. In this example, the transfer table 400 contains the following attributes: a TransferTableID starting from index 1 and incrementing by 1 per record; an Action Code field having terms such as “insert,” “update” and “delete”; a Sequence (Seq(PX)) field starting from 0 and incrementing by 1 per column for a specific table, with 0 representing the first column from the source table X; a Databaseld (DBID) field which identifies an online request database (OnlineRequstDB) ID as “0” and an offline PKI generation database (OfflinePKIGenDB) ID as “1”; a Table Name field which identifies the source table name; an is KeyType field which identifies a Key Field for the source table X as “0” and other fields that are not the key field to the database as “1”; a ColumnName field which is the column name of the source table; a ColumnDataType field which is the data field that needs to be transferred from the source to the target table; an IntegerData field which includes the term “integer” if the ColumnDataType is “integer” data; a StringData field which includes the term “string” if the ColumnDataType is “string” data; a FloatData field which includes the term “float” if the ColumnDataType is “float” data; a DatetimeData field that includes the term “datetime” if the ColumnDataType is “datetime” data; a BinaryData field that includes the term “binary” if the ColumnDataType is “binary” data; a TrandferredStatus field that includes a “0” for data that has not yet been transferred and a “1” for the data that is successfully transferred and any value less than “0” for different error conditions; and a TransferDatetime field that includes information representing the date and time that the data is transferred. As can be appreciated by one skilled in the art, the transfer table 400 can include additional columns including any other appropriate type of fields.

Accordingly, in the example shown, it can be seen that the information from the UserInfo Table (identified as Table 1 in this example) is placed into certain fields within the transfer table 400. As indicated, the information in the first record in the first row of the UserInfo Table is populated in the appropriate columns in the first four rows of the transfer table 400. A “1” is entered in the fields in the first four rows under the “TransTblID” column to signify that these first four rows of the transfer table 400 include the first record of the UserInfo Table. Since the operation is an “insert” operation, that is, the information from the UserInfo Table of database 116 to a corresponding Table 1 in the database 124, the term “insert” is entered in the fields in the first four rows of the “Action Code” column. Numbers “0”, “1”, “2” and “3” are entered in the fields in the first four rows of the “Seq(PX)” column of the transfer table 400 representing the four columns of information in the UserInfo Table. Also, a “0” is entered in the fields in the first four rows of the “DBID” column of the transfer table 400 to represent that the information being placed in the transfer table 400 is being taken from a table in the database 116. A “1” is placed in the field in the first row of the “IsKey Type” column of the transfer table 400 to represent that the corresponding information in that row of transfer table 400 is the key field to the UserInfo Table, while a “0” is ” is placed in the second through fourth fields in the first row of the “IsKey Type” column of the transfer table 400 to represent that the corresponding information in those row of transfer table 400 is not a key field of the UserInfo Table.

As further indicated, the names of the columns of the first record (row) in the UserInfo Table are placed in the fields in the first four rows of the “Column Name” column of the transfer table 400. The term “integer” is placed in the field in the first row of the “Column Data Type” column of the transfer table 400 to represent that the corresponding information entered in that row of transfer table 400 from the UserInfo Table is integer information, while the term “string” is placed in the fields in the second and third rows of the “Column Data Type” column of the transfer table 400 to represent that the corresponding information in those rows of transfer table 400 is string information, and the term “binary” is placed in the field in the fourth row of the “Column Data Type” column to represent that the corresponding information in that row of transfer table 400 is binary information.

A “1” is placed in the field in the first row of the “Integer Data” column of the transfer table 400 to represent the UserID of the first row of the UserInfo Table, and “null” is placed in the fields in the second through fourth rows of the “Integer Data” column of the transfer table 400 to represent that the corresponding information in those rows of transfer table 400 is not integer data. The username “Joe F.” is placed in the field in the second row of the “String Data” column of transfer table 400, the password “XXXX” is placed in the field in the third row of the “String Data” column of transfer table 400, and the user certificate “binary data” is placed in the field in the fourth row of the “String Data” column of transfer table 400. A “null” is entered in the fields of the first four rows of columns “Float Data” and “DateTime Data” of transfer table 400 to indicate that no such information is in that first record taken from the UserInfo Table, and a “null” is entered in the fields of the first three rows of column “Binary Data” of transfer table 400 to indicate that the first three fields in that first record taken from UserInfo Table is not binary data. However, the field in the fourth row of the “Binary Data” column of transfer table 400 includes the “binary data” as indicated. When the data from the first record in the UserInfo Table has been successfully transferred to the transfer table 400, a “1” is entered in the fields in the first four rows under the “Trans Status” column of transfer table 400, and the “DateTime” information representing the date and time of the transfer is entered in the fields in the first four rows under the “TransDate Time” column of transfer table 400.

As can further be appreciated from FIGS. 5 and 6, the rows of fields in the transfer table 400 is populated with information from the other two records in the UserInfo Table and the appropriate related information. As indicated, information from the record for UserID 2 and related information are populated into four respective rows of fields of the transfer table 400 below the four rows in which information from the UserID 1 record is populated. Information from the record for UserID 88 and related information are populated into four respective rows of fields of the transfer table 400 below the four rows in which information from the User ID 2 record is populated. For the records of ProductIDs 101 and 201 in the ProdInfo Table (Table 2), since those records are each only three columns long, three respective rows of transfer table 400 are populated with the respective information from the ProductID records 101 and 201 and the appropriate related information. Since the records of OrderIDs 1001 and 2001 in the OrderInfo Table (Table 3) are each four columns long, four respective rows of transfer table 400 are populated with the respective information from the OrderID records 1001 and 2001 and the appropriate related information as indicated. Again, once the transfer table 400 has been built, the transfer table 400 can be converted into a file, and the coordinator 120 can then load the file onto a device 402, such as a USB device as discussed above, to transfer the information in the transfer table 400 to the Tables 1 through n of the database 124 in the manner discussed above (e.g., using the workstation 126). As can further be appreciated by one skilled in the art, the methodology described above with regard to FIGS. 4-6 can also be used to transfer information from database 124 to database 116.

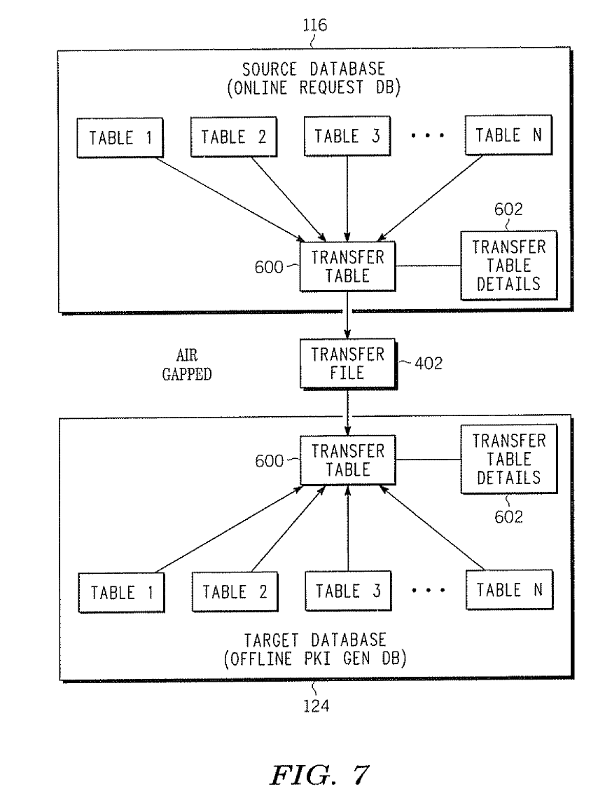

FIG. 7 illustrates an example of the manner in which multiple generic transfer tables, in particular, a header table 600 and a details table 602, can be used to transfer information from Tables 1 through n in a source database, such as database 116, to Tables 1 through n in a target database, such as database 124, according to an embodiment of the present invention. As can be appreciated by one skilled in the art, certain SQL system calls can be made by the PKI Synchronizer application, for example, when the coordinator 120 wishes to transfer, update or delete data using the database trigger mechanism or request based mechanism as discussed above with regard to FIGS. 2 and 3. The SQL system calls can retrieve information such as table name, number of columns in a table, column type, column size and so on, from the Tables 1 through n of the database 116. This retrieved information is then used to dynamically build scripts to gather data from all of the Tables 1 through n of the database 116 and place the gathered data in the header table 600 and details table 602. Once the header table 600 and details table 602 have been built, the information in these two tables 600 and 602 are converted and saved to a transfer file in a USB device first. This file will be manually transferred by a coordinator to the target database 124 in a different network to construct the information in the header table 600 and details table 602 to the Tables 1 through n in the manner discussed above (e.g., using the workstation 126).

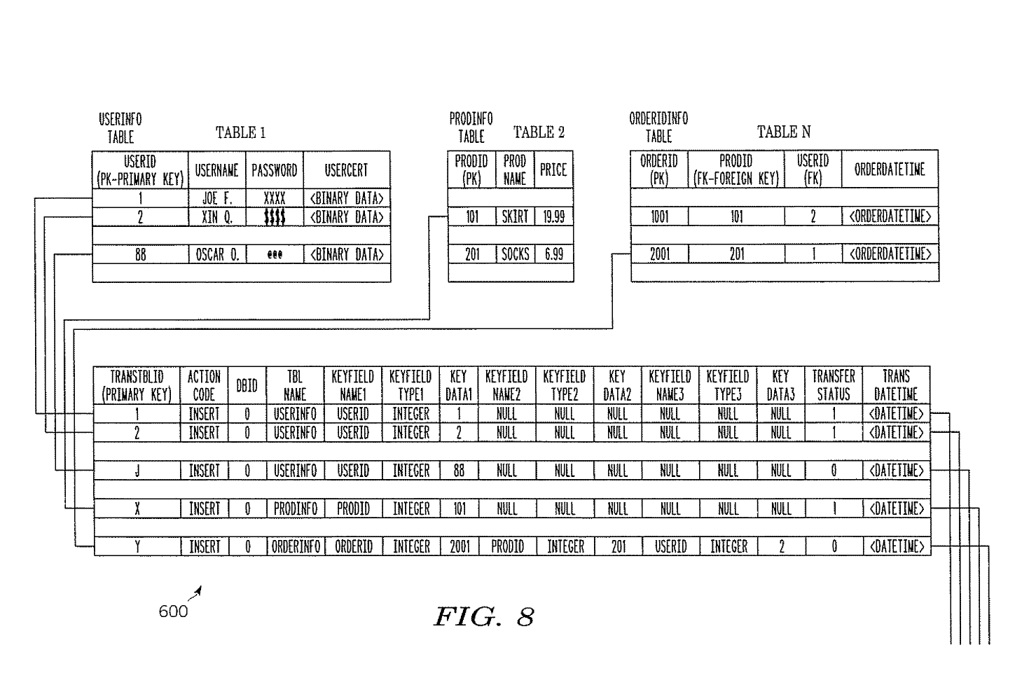

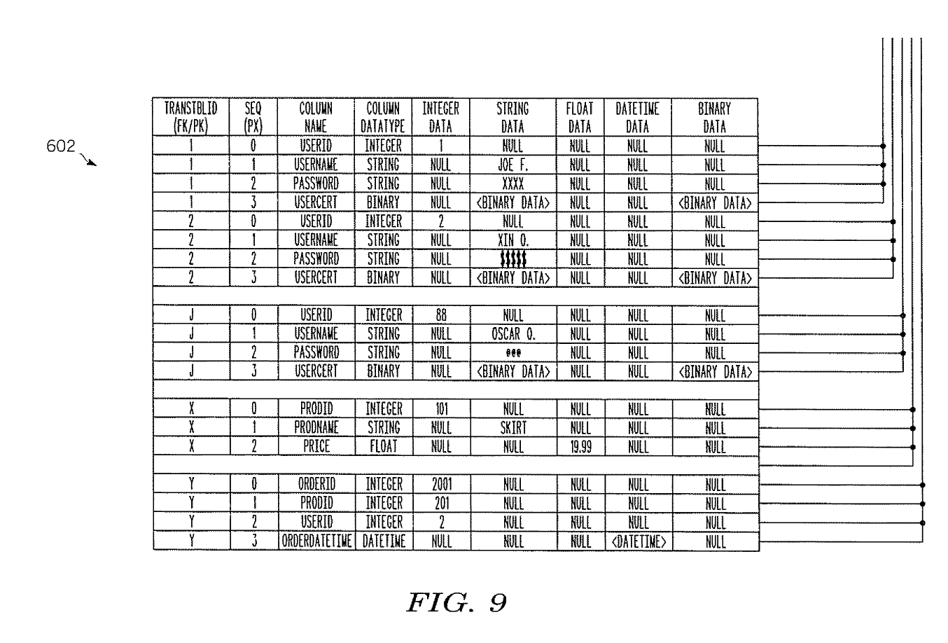

As shown in FIGS. 8 and 9, according to an embodiment of the present invention, the header table 600 and details table 602 can be used to hold the information that needs to be transferred from the source tables to the target tables or, in other words, from the database 116 (OnlineRequstDB) to the database 124 (OfflinePKIGenDB). In this example, the header table 600 contains the following attributes: a TransferTableID starting from index 1 and incrementing by 1 per record; an Action Code field having terms such as “insert,” “update” and “delete”; a Databaseld (DBID) field which identifies an OnlineRequstDB ID as “0” and an OfflinePKIGenDB ID as “1”; a Table Name field which identifies the source table name; a KeyFieldName field which identifies the key field name of a source table; a KeyFieldDataType field which identifies the data type of the key field; a KeyData field which indicates the value of the key field; a KeyField2Name field which indicates the second key field name; a KeyField2DataType which indicates the data type of the second key field; a KeyData2 field which indicates the value of the second key field; a KeyFieldxName field which indicates the number “x” key field name (“x” being “3” in the example shown in FIGS. 8 and 9; a KeyFieldxDataType which indicates the data type of the number “x” key field; a KeyDatax field which indicates the value of the number “x” key field; a TrandferredStatus field that includes a “0” for data that has not yet been transferred and a “1” for the data that is successfully transferred and any value less than “0” for different error conditions; and a TransferDatetime field that includes information representing the date and time that the data is transferred. As can be appreciated by one skilled in the art, the header table 600 can include additional columns including any other appropriate type of fields.

As further shown in FIGS. 8 and 9, in this example, the details table 602 contains a TransferTableID which is a foreign key that is linked to the header table 600; a Sequence (Seq(PX)) field starting from 0 and incrementing by 1 per column for a specific record (row) from a table in the source database table, with 0 representing the first column of the record from the source table X; a ColumnName field which is the column name of the source table from which the information was taken and placed in the header table 600; a ColumnDataType field which is the type of a data field (for an example, it can be “integer”, “string”, “binary”, etc.) that needs to be transferred from the source to the target table; an IntegerData field which includes a integer value (for example, 1, 2, 88, 101, etc.) if the ColumnDataType is “integer” data and the value “null” for the data types other than “integer”; a StringData field which includes a string (for example “Joe F.”) if the ColumnDataType is “string” data and has the value of “null” for the data types other than “string”; a FloatData field which includes a “float” value if the ColumnDataType is “float” data and “null” for other types of data; a “DateTime Data” field including information representing the data and time that the information has been transferred to the header table 600; and a BinaryData field that includes the term “binary” if the ColumnDataType is “binary” data. The details table 602 can also include additional columns including any other appropriate types of fields.

Accordingly, in the example shown, it can be seen that the information from the UserInfo Table (identified as Table 1 in this example) is placed into certain fields within the header table 600 and details table 602. As indicated, the information pertaining to the first record in the first row of the UserInfo Table (Table 1) is populated in the appropriate fields of the first row of the header table 600 and the first four rows of the details table 602. A “1” is entered in the field in the first row under the “TransTblID” column to signify that this row of the header table 600 include information pertaining to the first record of the UserInfo Table. Since the operation is an “insert” operation, that is, the information from the UserInfo Table of database 116 to a corresponding Table 1 in the database 124, the term “insert” is entered in the field in the first row of the “Action Code” column.

Also, a “0” is entered in the field in the first row of the “DBID” column of the transfer table 400 to represent that the information being placed in the header table 600 is being taken from a table in the database 116 (OnlineRequstDB). The name “UserInfo” is placed in the field of the first row of the Tbl Name column of the header table 600 to indicate that the information pertains to a record in the UserInfo Table. The term “UserID” is placed in the field of the first row of the KeyFieldName1 column of the header table 600 to indicate the name of the key field in Table 1. The term “integer” is placed in the field of the first row of the KeyFieldType1 column of the header table 600 to indicate the type of information in that the key 1 field in Table 1 is integer information, and the UserID “1” is placed in the field of the first row of the KeyData1 column of the header table 600 to correspond to the UserID “1” in the first record of Table 1. Since no additional key fields are present in Table 1, a “null” is entered in the field in the first row of each of the columns KeyField2Name, KeyField2DataType, KeyData2, KeyField3Name, KeyField3DataType and KeyData3 since no such key information is present in the first record of Table 1. A “1” is included in the field in the first row of the TransferredStatus column to indicate that the data has been successfully transferred, and the date and time information indicating the date and time of the transfer is included in the field in the first row of the TransferDatetime column.

As further shown in FIGS. 8 and 9, information pertaining to the first record in Table 1 is included in the details table 602. That is, a “1” is entered in the fields in the first four rows under the “TransTblID” column to signify that these first four rows of the details table 602 include the first record of the UserInfo Table (Table 1). Numbers “0”, “1”, “2” and “3” are entered in the fields in the first four rows of the “Seq(PX)” column of the details table 602 representing the four columns of information in the UserInfo Table. The term “integer” ” is placed in the field in the first row of the “Column Data Type” column of the details table 602 to represent that the corresponding information entered in that row of details table 602 from the UserInfo Table is integer information, while the term “string” is placed in the fields in the second and third rows of the “Column Data Type” column of the details table 602 to represent that the corresponding information in those rows of details table 602 is string information, and the term “binary” is placed in the field in the fourth row of the “Column Data Type” column to represent that the corresponding information in that row of details table 602 is binary information.

A “1” is placed in the field in the first row of the “Integer Data” column of the details table 602 to represent the UserID of the first row of the UserInfo Table, and “null” is placed in the fields in the second through fourth rows of the “Integer Data” column of the details table 602 to represent that the corresponding information in those rows of details table 602 is not integer data. The username “Joe F.” is placed in the field in the second row of the “String Data” column of details table 602, the password “XXXX” is placed in the field in the third row of the “String Data” column of details table 602, and the user certificate “binary data” is placed in the field in the fourth row of the “String Data” column of details table 602. A “null” is entered in the fields of the first four rows of columns “Float Data” and “DateTime Data” of details table 602 to indicate that no such information is in that first record taken from the UserInfo Table, and a “null” is entered in the fields of the first three rows of column “Binary Data” of details table 602 to indicate that the first three fields in that first record taken from UserInfo Table is not binary data. However, the field in the fourth row of the “Binary Data” column of details table 602 includes the “binary data” as indicated.

As can further be appreciated from FIGS. 8 and 9, the rows of fields in the header table 600 and details table 602 are populated with information from the other two records in the UserInfo Table and the appropriate related information. As indicated, information from the record for UserID 2 and related information are populated into four respective rows of fields of the details table 602 below the four rows in which information from the UserID 1 record is populated. Information from the record for UserID 88 and related information are populated into four respective rows of fields of the details table 602 below the four rows in which information from the User ID 2 record is populated.

As indicated in FIG. 8 and 9, the information pertaining to the 101th record in the 101th row of the ProdInfo table is populated in the appropriate fields of the Xth row of the header table 600 and three respective rows of the details table 602 since this record in the ProdInfo table is only three columns long. In this example, the record of ProductID 201 is not transferred. Also, since the records of OrderID 2001 in the OrderInfo Table (Table 3) are populated to one row (record) in the header table 600 and four columns long, four respective rows of details table 602 are populated with the respective information from the OrderID record 2001 and the appropriate related information as indicated. In this example, the record of OrderID record 1001 is not transferred. Again, once the header table 600 and details table 602 have been built, the header table 600 and details table 602 are converted to a transfer file. The coordinator 120 can then load the file onto a device 402, such as a USB device as discussed above, to transfer the information in the header table 600 and details table 602 to the Tables 1 through n of the database 124 in the manner discussed above (e.g., using the workstation 126). As can further be appreciated by one skilled in the art, the methodology described above with regard to FIGS. 7-9 can also be used to transfer information from database 124 to database 116.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for updating at least one record in a target database based on information in at least one record in a source database, with one of the target and source databases being in a public network and the other of the source and target databases being in a secure network that is air gap secured from the public network, the method comprising:
identifying said at least one record of information in the source database to be updated in the target database;
entering update information in at least one data transfer table based on said at least one record of information; and
using said at least one data transfer table to update said at least one record in the target database in accordance with said update information without overwriting other information in the target database.

2. A method as claimed in claim 1, wherein:
said entering step enters said update information in a plurality of data transfer tables.

3. A method as claimed in claim 2, wherein:
said plurality of data transfer tables includes a header table into which update information that identifies said at least one record of information is entered, and a details table into which update information corresponding to the information in said at least one record is entered.

4. A method as claimed in claim 1, wherein:
said information in the source database includes at least one of binary data and variable-length data field data.

5. A method as claimed in claim 1, wherein:
said at least one record of information in the source database is arranged in a row format in the database; and
said update information is entered in said at least one data transfer table in column format.

6. A method as claimed in claim 1, wherein said using step comprises:
loading a file representing said at least one table onto a device coupled to receive information from the source database;
uncoupling said device from the source database; and
coupling said device to the target database for use in updating said at least one record in the target database based on the file loaded onto the device.

7. A method as claimed in claim 1, wherein:
said identifying step comprises identifying a plurality of said records of information in the source database to be updated in the target database;
said entering step comprises entering update information in at least one data transfer table based on said plurality of records of information; and
said using step comprises using said at least one data transfer table to update a plurality of said records in the target database in accordance with said update information without overwriting other information in the target database.

8. A method as claimed in claim 1, wherein:
said update information includes information pertaining to one of insertion of a new record in the target database, updating of an existing record in the target database and deletion of an existing record from the target database.

9. A computer-readable medium of instructions for updating at least one record in a target database based on information in at least one record in a source database, with one of the target and source databases being in a public network and the other of the source and target databases being in a secure network that is air gap secured from the public network, the computer-readable medium of instructions comprising:
a first set of instructions for enabling a computer to identify said at least one record of information in the source database to be updated in the target database; and
a second set of instructions for enabling a computer to enter update information in at least one data transfer table based on said at least one record of information, said update information being configured for use in updating said at least one record in the target database in accordance with said update information without overwriting other information in the target database.

10. A computer-readable medium of instructions as claimed in claim 9, wherein:
said second set of instructions enables the computer to enter said update information in a plurality of data transfer tables.

11. A computer-readable medium of instructions as claimed in claim 10, wherein:
said plurality of data transfer tables includes a header table into which update information that identifies said at least one record of information is entered, and a details table into which update information corresponding to the information in said at least one record is entered.

12. A computer-readable medium of instructions as claimed in claim 9, wherein:
said information in the source database includes at least one of binary data and variable-length data field data.

13. A computer-readable medium of instructions as claimed in claim 9, wherein:
said at least one record of information in the source database is arranged in a row format in the source database; and
said update information is entered in said at least one data transfer table in column format.

14. A computer-readable medium of instructions as claimed in claim 9, wherein:
said first set of instructions enables the computer to identify a plurality of said records of information in the source database to be updated in the target database; and
said second set of instructions enables the computer to enter update information in at least one data transfer table based on said plurality of records of information, such that said at least one data transfer table is configured for use in updating a plurality of said records in the target database in accordance with said update information without overwriting other information in the target database.

15. A computer-readable medium of instructions as claimed in claim 9, wherein:
said update information includes information pertaining to one of insertion of a new record in the target database, updating of an existing record in the target database and deletion of an existing record from the target database.

16. A system comprising:
a public network comprising one of a source database and a target database;
a secure network comprising the other of the source database and the target database and air gap secured from the public network;
a computer, operable to identify at least one record of information in the source database to be updated in at least one record in the target database, and enter update information in at least one data transfer table based on said at least one record of information, such that said at least one data transfer table is configured for use in updating said at least one record in the target database in accordance with said update information without overwriting other information in the target database.

17. A system as claimed in claim 16, wherein:
said computer is operable to enter said update information in a plurality of data transfer tables.

18. A system as claimed in claim 17, wherein:
said plurality of data transfer tables includes a header table into which update information that identifies said at least one record of information is entered, and a details table into which update information corresponding to the information in said at least one record is entered.

19. A system as claimed in claim 16, wherein:
said information in the source database includes at least one of binary data and variable-length data field data; and
said at least one record of information in the source database is arranged in a row format in the source database, said update information is entered in said at least one data transfer table in column format.

20. A system as claimed in claim 16, further comprising:
a device, configured to couple to the computer associated with the source database to enable the computer to load a file representing said at least one table onto the device, and further configured to couple to a computer associated with the target database, when removed from the computer associated with the source database, to enable the computer associated with the target database to update said at least one record in the target database based on the file loaded onto the device.
